(19) United States
(12) Patent Application Publication
(10) Pub. No.: US 2026/0220965 A1
(43) Pub. Date: Jul. 30, 2026

(54) USER INTERFACES FOR IMAGE CAPTURE

(71) Applicant: DOLBY LABORATORIES LICENSING CORPORATION, San Francisco, CA (US)

(72) Inventors: Ben GANNON, San Francisco, CA (US); James MANNING, San Anselmo, CA (US); Andrea FANELLI, Seattle, WA (US); Hailong SHI, Beijing (CN); Xuemei YU, Beijing (CN); McGregor JOYNER, Alameda, CA (US); Alex BRANDMEYER, Berkeley, CA (US)

(73) Assignee: DOLBY LABORATORIES LICENSING CORPORATION, San Francisco, CA (US)

(21) Appl. No.: 19/140,093

(22) PCT Filed: Dec. 21, 2023
(86) PCT No.: PCT/CN2023/140671

§ 371 Date: Jun. 17, 2025

Related U.S. Application Data
(60) Provisional application No. 63/476,617, filed on Dec. 21, 2022.

(51) Int. Cl. G06V 40/16; G06F 3/01; G06F 3/0482; H04S 7/00

(52) U.S. Cl. CPC G06V 40/165; G06F 3/012; G06F 3/0482; G06V 40/174; H04S 7/303; H04S 2420/01

(57) ABSTRACT

The present disclosure generally relates to user interfaces and techniques for capturing image data. In some embodiments, method comprises: displaying, on the display, a user interface including a preview portion; displaying images in the preview portion corresponding to image data captured by the camera; and while displaying the images in the preview portion, performing a capture process including: capturing a series of images corresponding to preview images in the preview portion using the camera; and determining pose data associated with the series of images; in accordance with the pose data meeting or exceeding a first threshold, causing output of a first set of instructional prompts; and in accordance with the pose data meeting or exceeding a second threshold, causing output of a second set of instructional prompts; and ceasing the capture process in response to a determination that a set of sufficiency criteria are met.

### TECHNICAL FIELD

This disclosure relates generally to computer user interfaces, and more specifically to user interfaces and techniques for capturing image data for device personalization.

### BACKGROUND

Image data can be captured by a camera of an electronic device to enable device personalization or experience personalization for a user of the electronic device. Information concerning the image capture process can be presented to the user on a user interface (UI) displayed on a screen of the electronic device. Existing techniques for capturing image data using electronic devices are generally cumbersome, confusing, and inefficient. For example, some existing techniques use a complex and time-consuming UI, which may include multiple key presses or keystrokes. Furthermore, some existing techniques are error prone and result in a collection of image data that is unsuitable for enabling complex image-driven based personalization, such as generating a personalized head related transfer function (PHRTF) for audio playback. Existing techniques also require more time than necessary to complete the image capture, thereby consuming more device power than necessary, which is particularly important for battery-operated electronic devices.

### SUMMARY

Accordingly, the disclosed embodiments provide electronic devices with faster, more efficient methods and interfaces for capturing image data. In some embodiments, the electronic device (e.g., a desktop or notebook computer, smartphone, tablet computer) captures images and sends the images to a network server computer, and the electronic device receives PHRTF data from the server computer and applies the PHRTF data to audio to generate a personalized audio experience (e.g., spatial or immersive audio experience) for the user. The types of audio signals that can be processed using the PHRTF data include but are not limited to channel-based audio, object-based audio (e.g., 5.1.2, 7.1.2, 5.1.4, 7.1.4, 9.1.2), etc. In other embodiments, the electronic device captures images, selects particular ones of the images, calculates a PHRTF and applies the PHRTF to audio to generate the personalized audio experience for the user.

In accordance with some embodiments, a method performed at an electronic device including a display device is described. The method comprises: displaying, on the display, a user interface including a preview portion displaying images corresponding to image data captured by the camera; and while displaying the images in the preview portion, performing a capture process including: capturing a series of images corresponding to preview images in the preview portion using the camera; determining pose data associated with respective images of the series of images; in accordance with the pose data meeting or exceeding a first threshold, causing output of a first set of instructional prompts; and in accordance with the pose data meeting or exceeding a second threshold, causing output of a second set of instructional prompts; and ceasing the capture process in response to a determination that a set of sufficiency criterion are met.

In accordance with some embodiments, a non-transitory, computer-readable storage medium storing one or more programs configured to be executed by one or more processors of an electronic device with a display device and a camera is described. The one or more programs include instructions for: displaying, on the display, a user interface including a preview portion displaying images corresponding to image data captured by the camera; and while displaying the images in the preview portion, performing a capture process including: capturing a series of images using the camera and determining pose data associated with respective images of the series of images; in accordance with the pose data meeting or exceeding a first threshold, causing output of a first set of instructional prompts; in accordance with the pose data meeting or exceeding a second threshold, causing output of a second set instructional prompts; and ceasing the capture process in response to a determination that a set of sufficiency criterion are met.

In accordance with some embodiments, a transitory, computer-readable storage medium storing one or more programs configured to be executed by one or more processors of an electronic device with a display device and a camera is described. The one or more programs include instructions for: displaying, on the display, a user interface including a preview portion displaying images corresponding to image data captured by the camera; and while displaying the images in the preview portion, performing a capture process including: capturing a series of images using the camera and determining pose data associated with respective images of the series of images; in accordance with the pose data meeting or exceeding a first threshold, causing output of a first set of instructional prompts; in accordance with the pose data meeting or exceeding a second threshold, causing output of a second set of instructional prompts; and ceasing the capture process in response to a determination that a set of sufficiency criterion are met.

In accordance with some embodiments, an electronic device is described. The electronic device comprises a display device; a camera; one or more processors; and memory storing one or more programs configured to be executed by the one or more processors, the one or more programs including instructions for: displaying, on the display, a user interface including a preview portion displaying images corresponding to image data captured by the camera; and while displaying the images in the preview portion, performing a capture process including: capturing a series of images using the camera and determining pose data associated with respective images of the series of images; in accordance with the pose data meeting or exceeding a first threshold, causing output of a first set of instructional prompts; in accordance with the pose data meeting or exceeding a second threshold, causing output of a second set of instructional prompts; and ceasing the capture process in response to a determination that a set of sufficiency criteria are met.

In accordance with some embodiments, an electronic device is described. The electronic device comprises a display device; a camera and means for displaying, on the display, a user interface including a preview portion displaying images corresponding to image data captured by the camera; and means for while displaying the images in the preview portion, means for performing a capture process including: capturing a series of images using the camera and determining pose data associated with respective images of the series of images; and means for in accordance with the pose data meeting or exceeding a first threshold, and means for causing output of a first set of instructional prompts; in accordance with the pose data meeting or exceeding a second threshold, and means for causing output of a second set of instructional prompts; and means for ceasing the capture process in response to a determination that a set of sufficiency criterion are met.

In accordance with some embodiments, a method comprises: presenting a user interface on a display of an electronic device, the user interface including a preview portion for displaying images captured by a camera of the device; presenting in the user interface a first instruction to the user to a rotate their head in a first direction; capturing a first set of images of the user's first ear in the target area; presenting in the user interface a second instruction to the user to a rotate their head in a second direction, opposite the first direction; capturing a second set of images of the user's second ear in the preview portion; generating a final set of images from the second and third sets of images by selecting a subset of the first and second sets of images that have a minimum angular distance of head rotation of the user captured in the images; and generating data corresponding to a set of personalized head related transfer functions (PHRTFs) for the user based on the final set of images.

In accordance with some embodiments, the final set of images have an overall maximum angular distance of head rotation of the user that is less than 110 degrees.

In accordance with some embodiments, the method further comprises scaling at least a portion of the first and second sets of images based on one or more frontal view images of the user.

In accordance with some embodiments, a method comprises: at an electronic device with a display: displaying, on the display, a user interface including a graphical object at a first size, a slider affordance including an indicator located at a first position on the slider affordance, and a first text description corresponding to the first position of the indicator on the slider affordance; and while displaying the graphical object: detecting user input; responsive to detecting the user input: updating the indicator position from the first position to a second position on the slider affordance; displaying the graphical object at a second size that is smaller or larger than the first size; and displaying a second text description corresponding to the second position of the indicator on the slider affordance in place of the first text description.

In accordance with some embodiments, the method further comprises generating personalized head related transfer function (PHRTF) data corresponding to a set of PHRTF related transfer functions based on data corresponding to the displayed size of the graphical object and the first or second text description and a generative model.

In accordance with some embodiments, generating PHRTF data corresponding to a set of PHRTF related functions is performed in response to detecting user input at a create profile affordance presented on the touch sensitive display.

In accordance with some embodiments, generating PHRTF data includes applying demographic data associated with the user to the generative model.

In accordance with some embodiments, generating the PHRTF data excludes using image data corresponding to the user.

In accordance with some embodiments, the first size of the graphical object is smaller than the second size of the graphical object.

In accordance with some embodiments, the first size of the graphical object is larger than the second size of the graphical object.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

The disclosed embodiments provide at least one or more of the following advantages. The disclosed methods and user interfaces optionally complement or replace other methods for capturing image data through user interfaces. The disclosed methods and interfaces reduce the cognitive burden on a user and provide a more efficient human-machine interface. For battery-operated computing devices, the disclosed methods and user interfaces conserve power and increase the time between battery charges. Thus, electronic devices are provided with faster, more efficient methods and user interfaces for capturing image data, thereby increasing the effectiveness, efficiency, and user satisfaction with such electronic devices and also reducing power consumption with such electronic devices.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 is a block diagram illustrating a portable multifunction device with a touch-sensitive display in accordance with some embodiments.

FIG. 2 illustrates a portable multifunction device having a touch screen in accordance with some embodiments.

FIGS. 3A-3V are screen shots of user interfaces for capturing image data using an electronic device, in accordance with some embodiments.

FIGS. 4A and 4B are a flow diagram illustrating a process for capturing image data using an electronic device, in accordance with some embodiments.

FIGS. 5A-5K are screen shots of a first alternative user interface for capturing image data using an electronic device, in accordance with some embodiments.

FIGS. 6A-6E are screen shots of a second alternative user interface for creating a PHRTF without capturing images, in accordance with some embodiments.

FIG. 7 is a flow diagram illustrating a process for generating a PHIRTF without capturing images, in accordance with some embodiments.

FIG. 8 is a flow diagram illustrating a process for capturing image data using an electronic device, in accordance with some embodiments.

### DETAILED DESCRIPTION

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for capturing image data. For example, there is a need for an electronic device that provides a user with information about an ongoing image capture process in an easily understandable and convenient manner. In another example, there is a need for an electronic device that effectively provides feedback to the user of the electronic device while capturing data used for enabling device personalization such as personalized audio playback. Such techniques can reduce the cognitive burden on a user operating the electronic device, thereby enhancing productivity. Further, such techniques can reduce processor and battery power otherwise wasted on redundant user inputs.

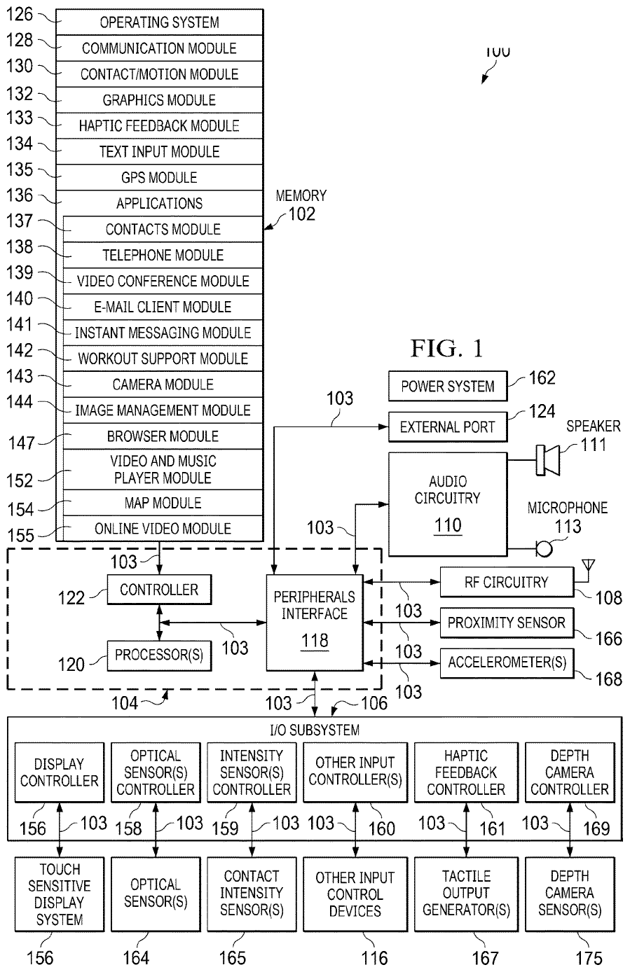

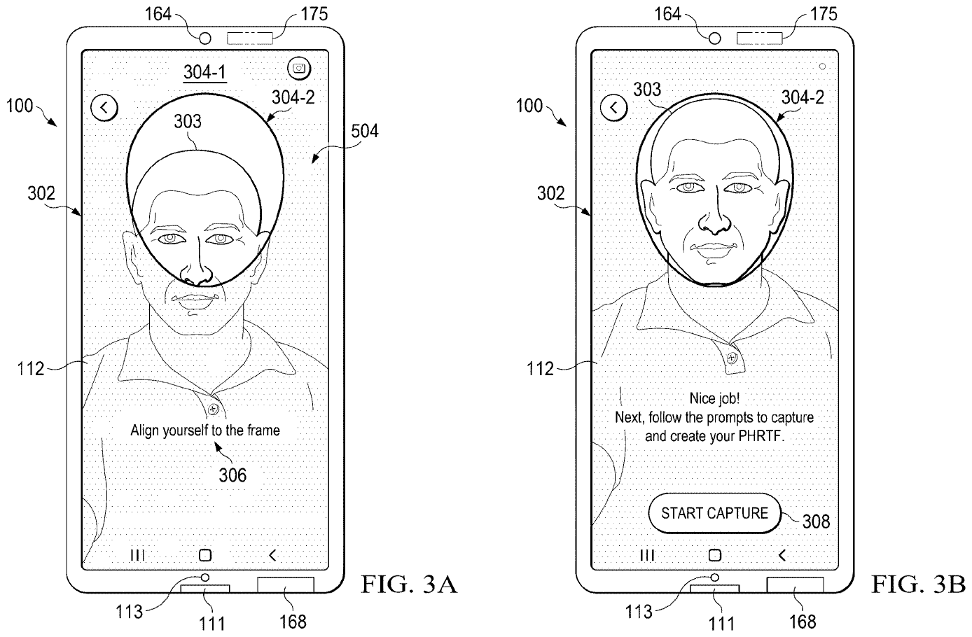

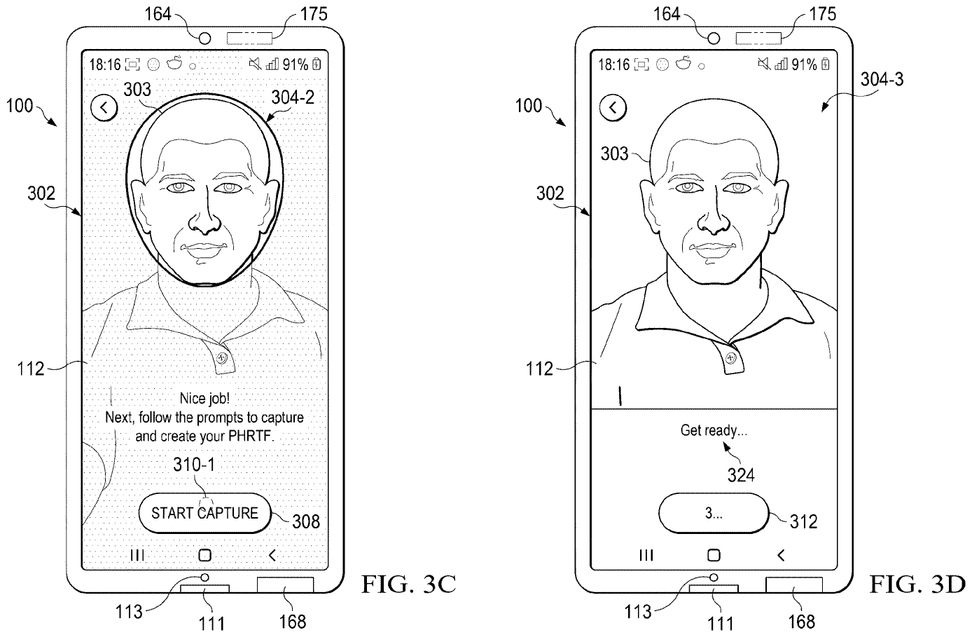

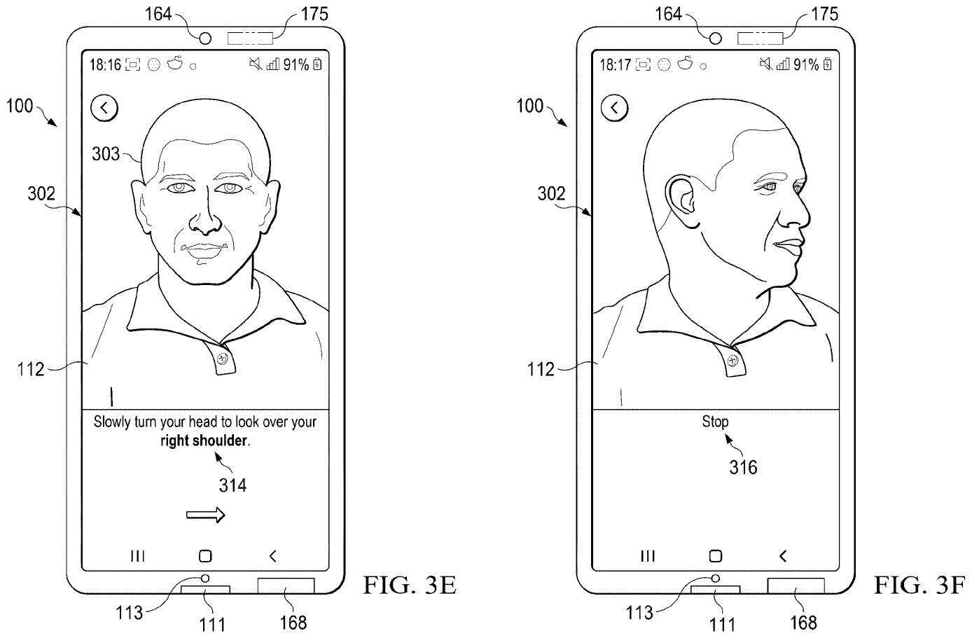

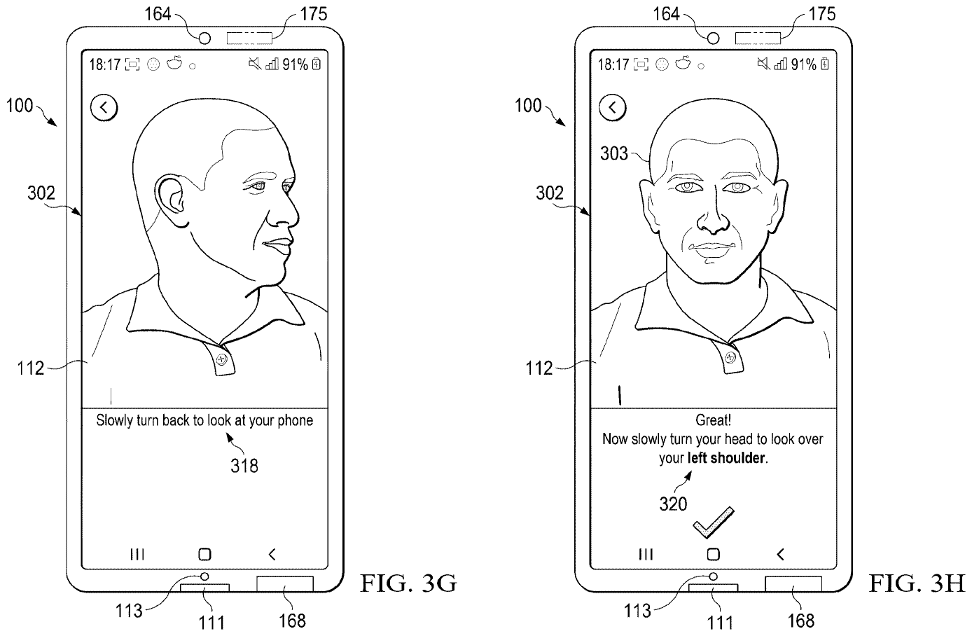

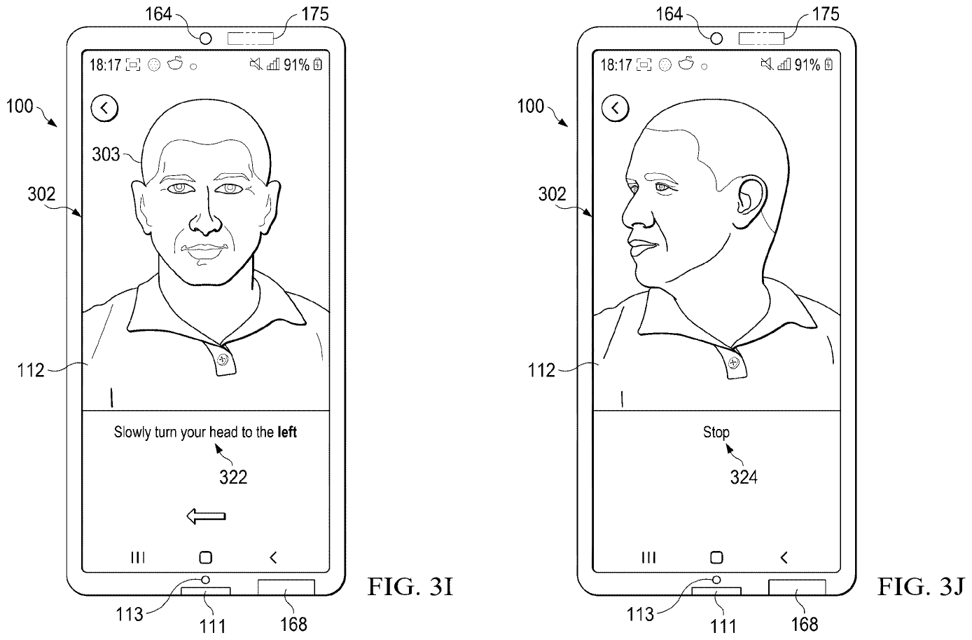

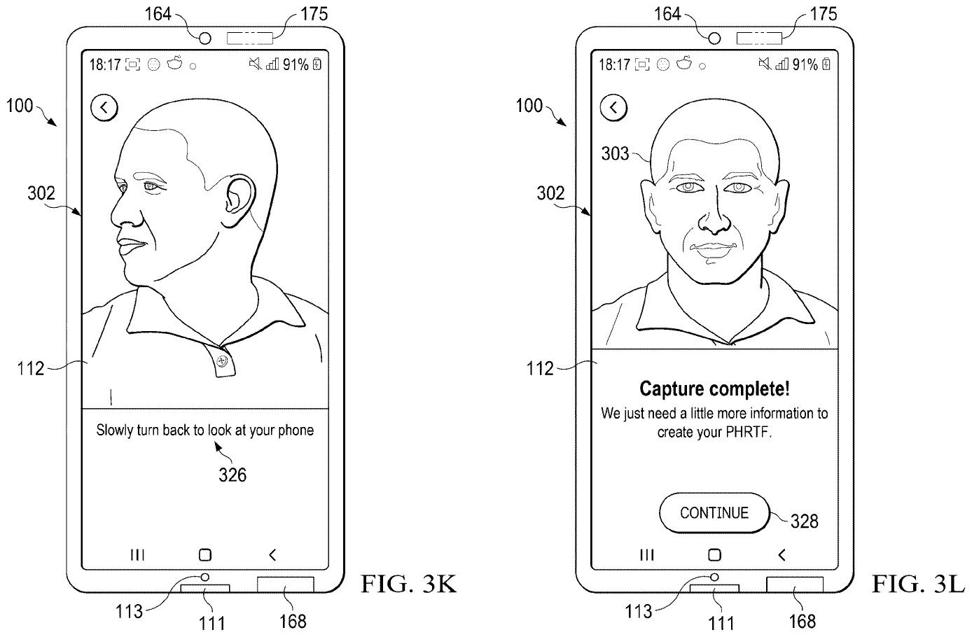

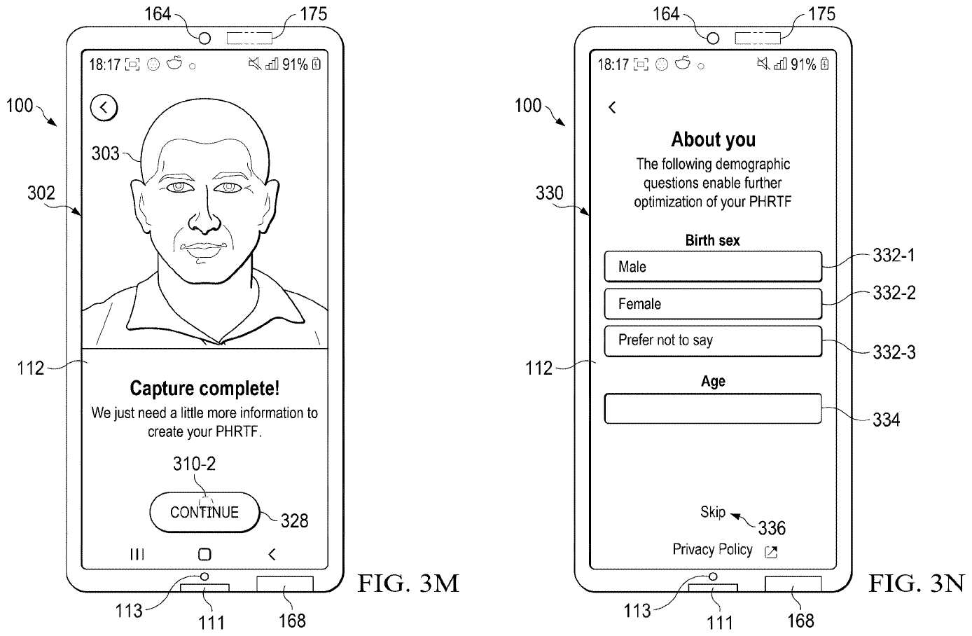

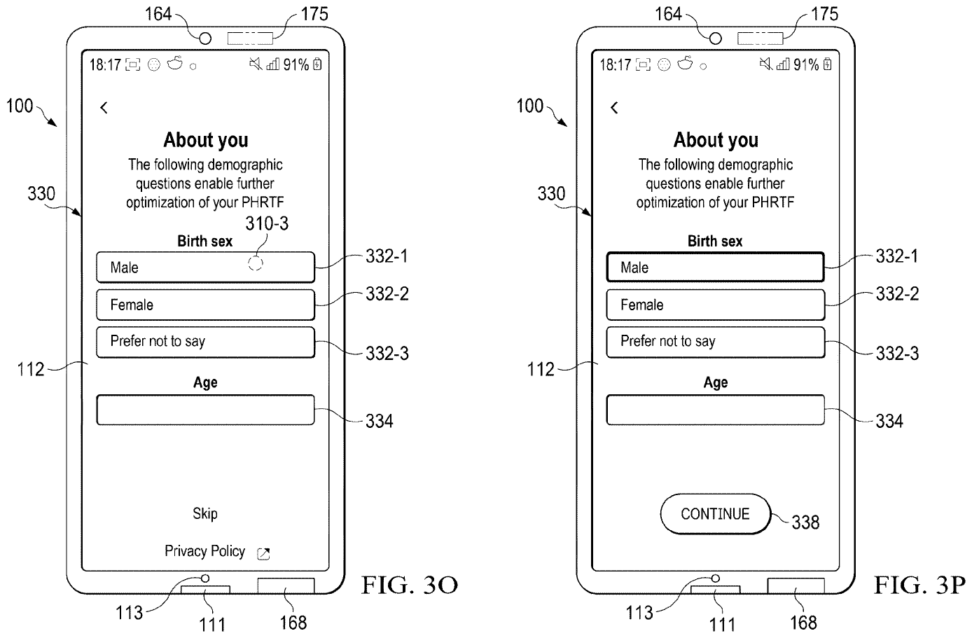

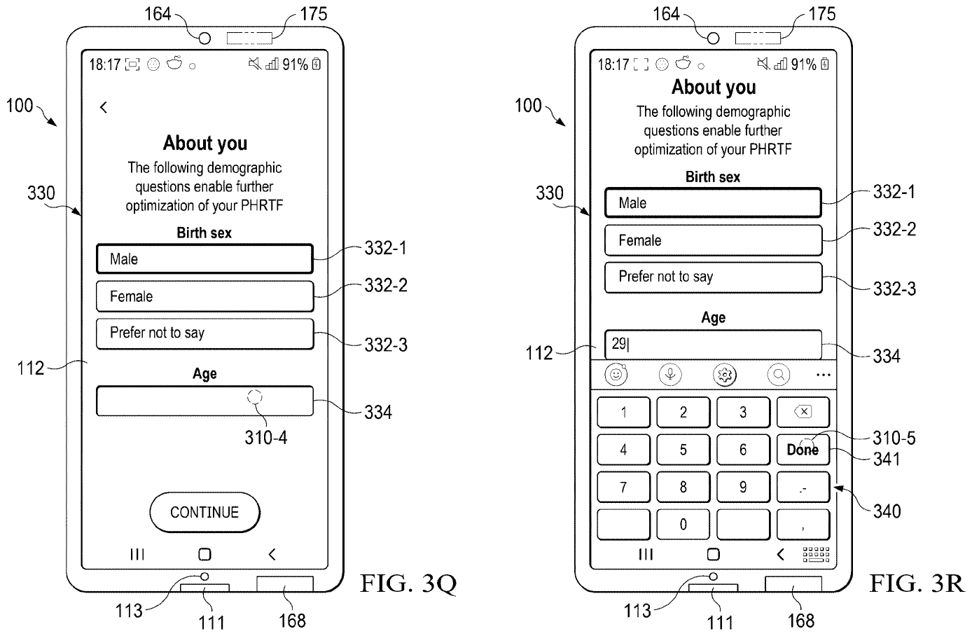

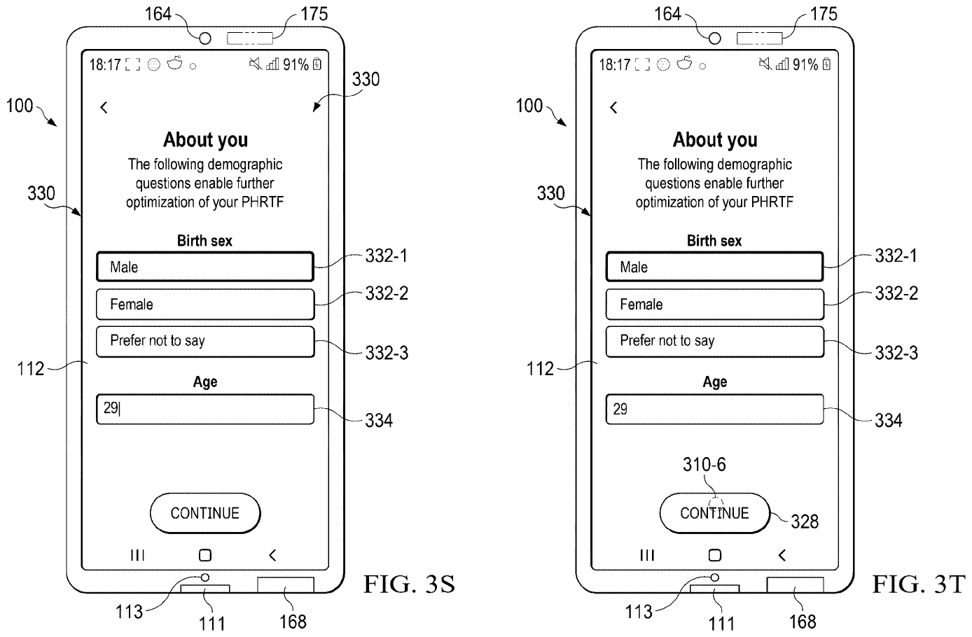

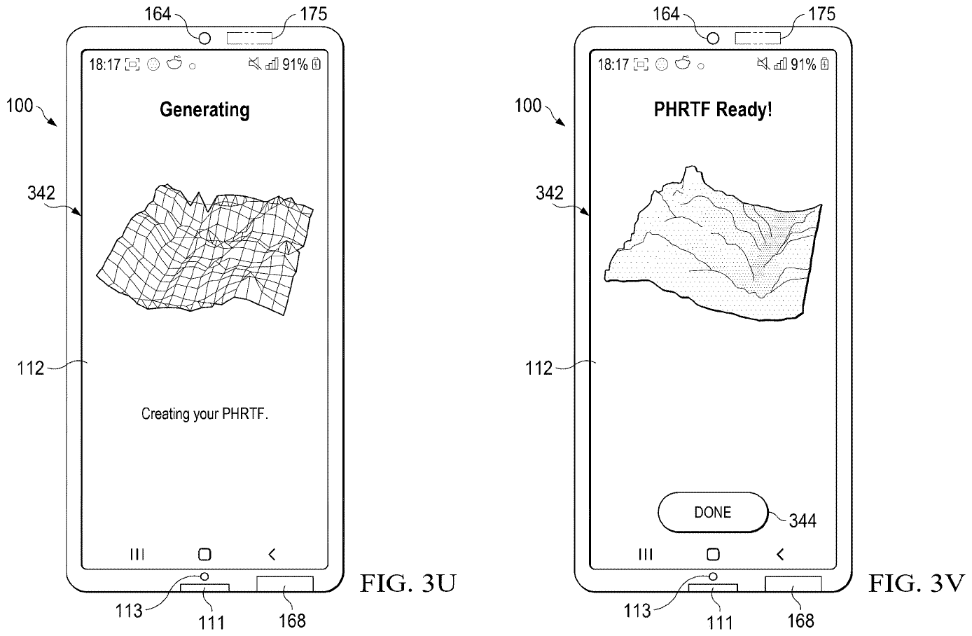

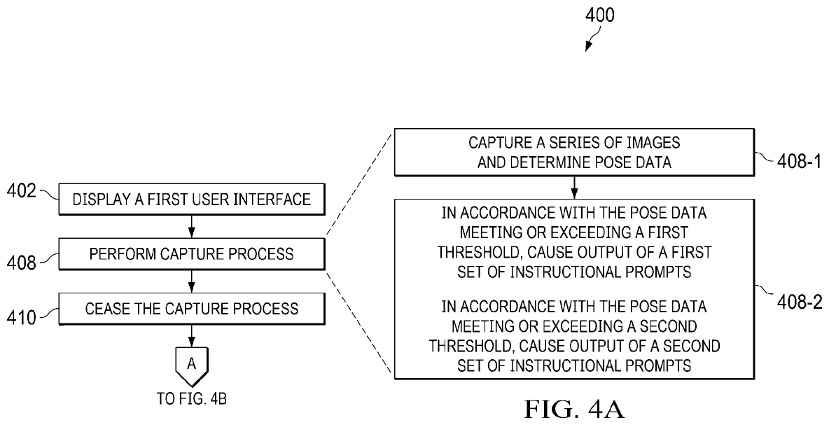

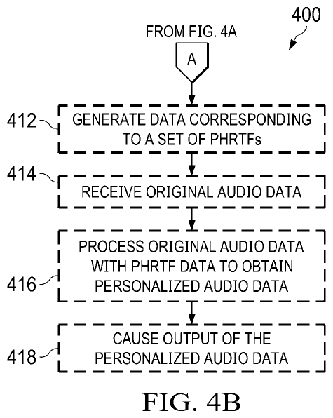

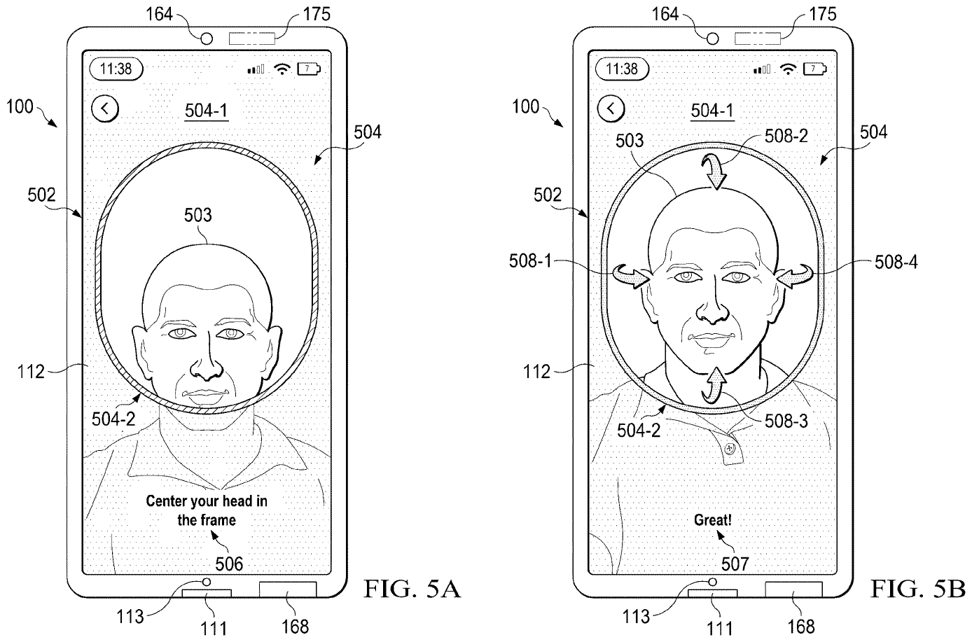

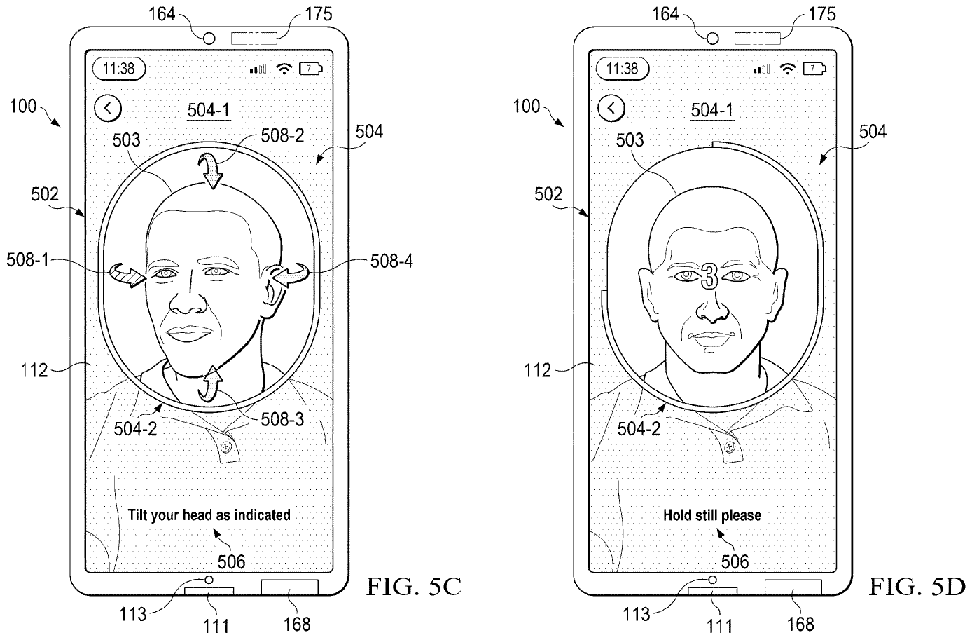

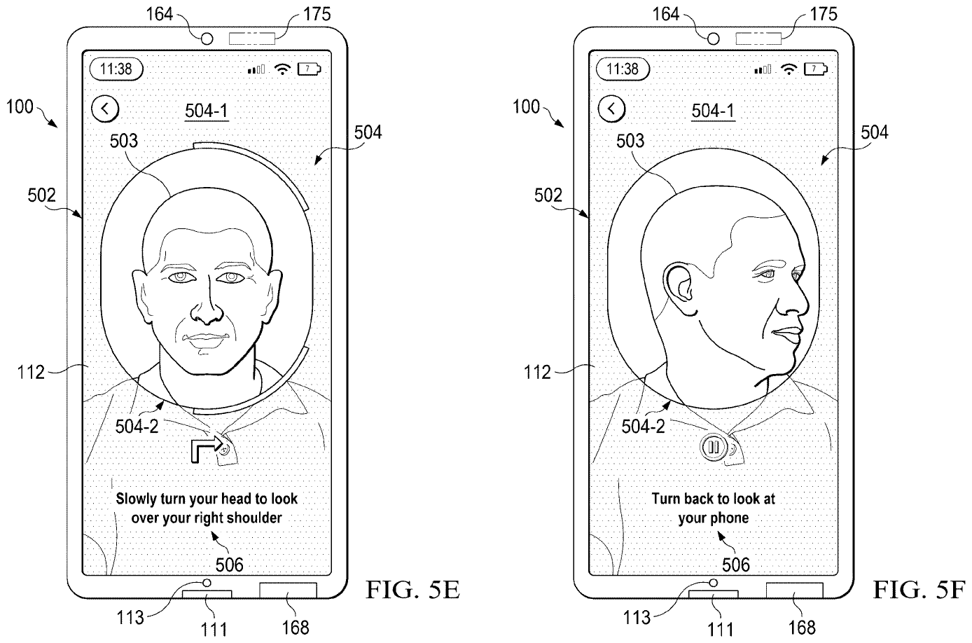

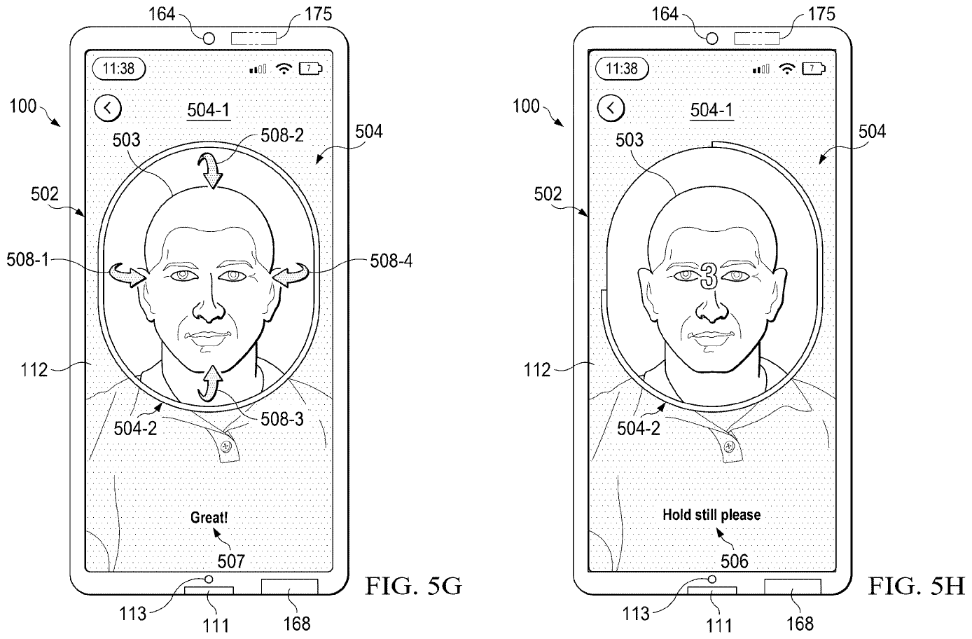

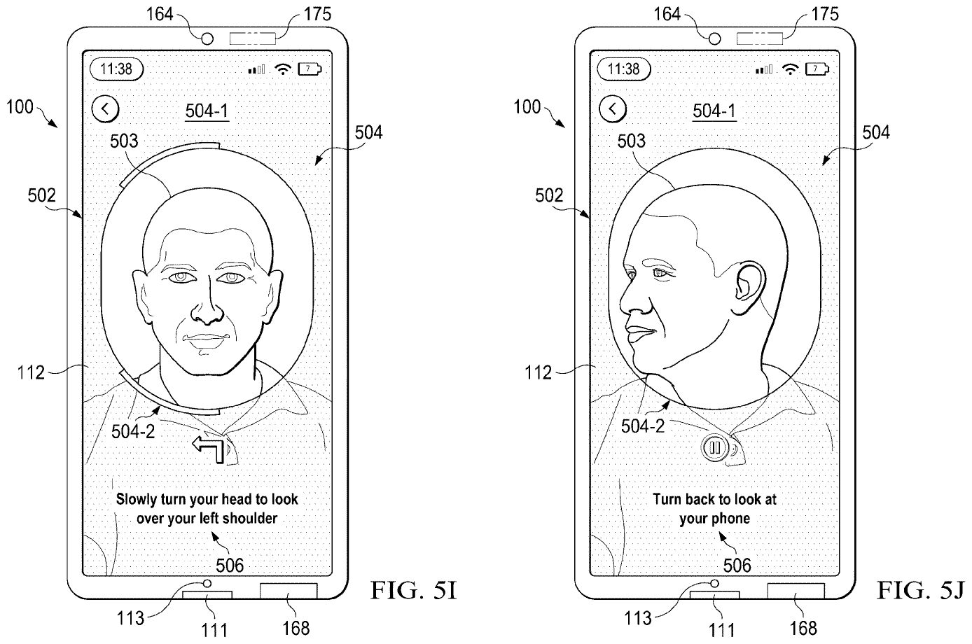

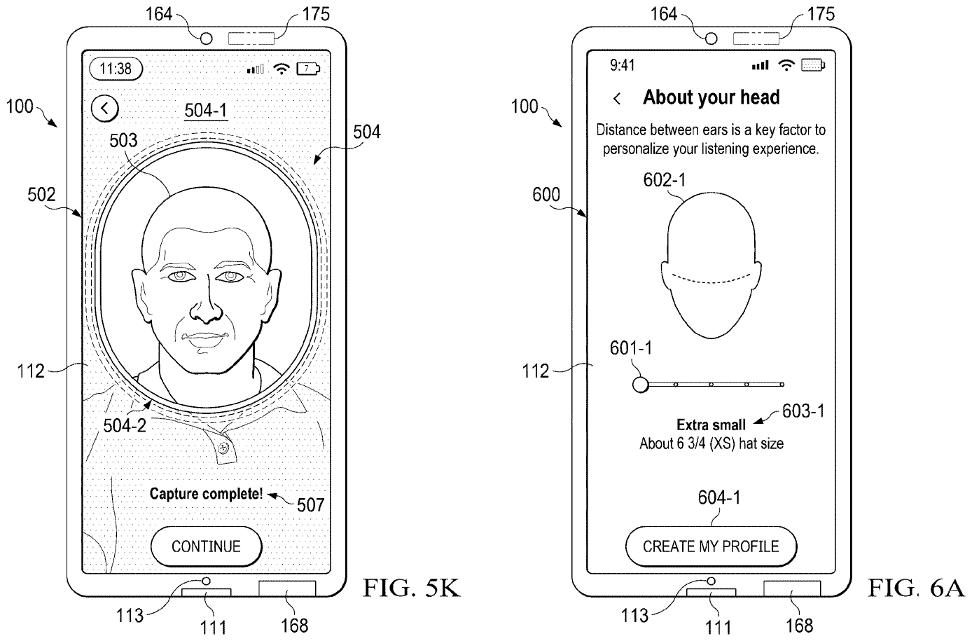

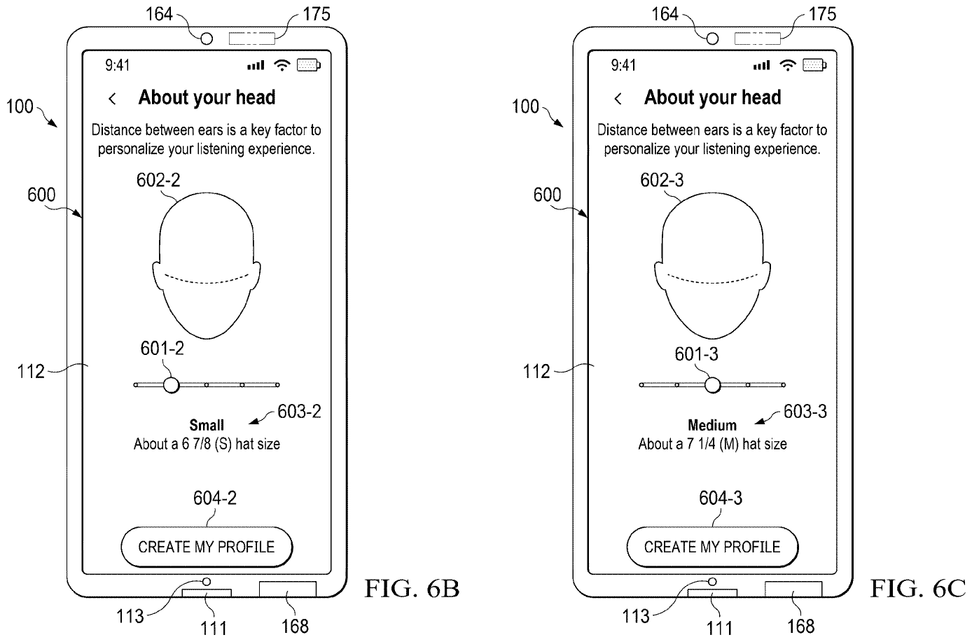

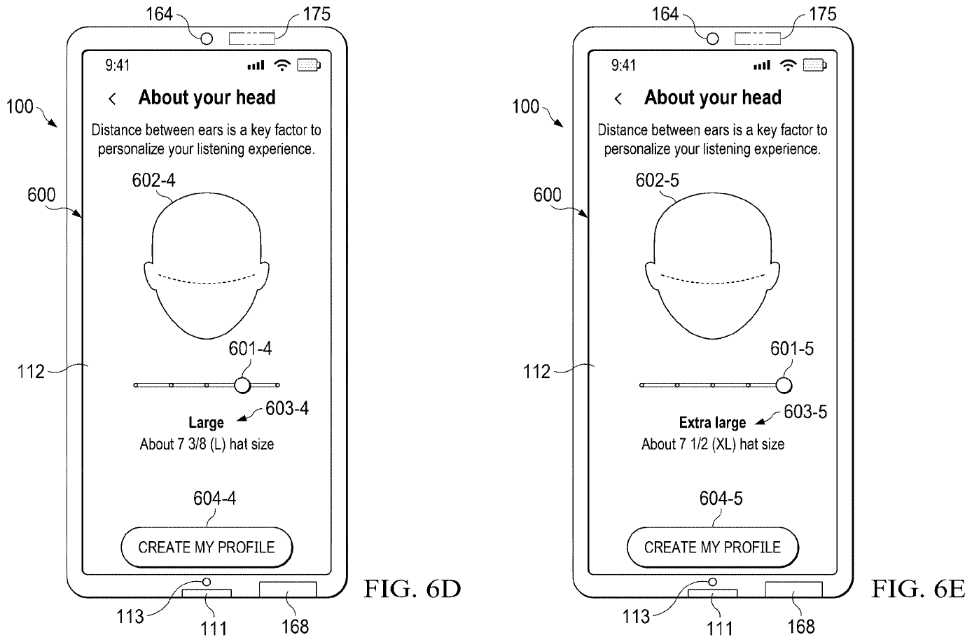

Below, FIGS. 1, 2, 3A-3V, and 4A and 4B provide a description of exemplary devices for performing the embodiments for capturing image data. FIGS. 3A-3V illustrate exemplary user interfaces for capturing image data. FIGS. 4A and 4B are a flow diagram illustrating a method for capturing image data using an electronic device, in accordance with some embodiments. The user interfaces in FIGS. 3A-3V are used to illustrate the processes described below, including the processes in FIGS. 4A and 4B. FIGS. 5A-5K are used to illustrate an alternative method and user interfaces for capturing image data. FIGS. 6A-6E are used to illustrate alternative method for creating PHRTFs without image capture.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Other portable electronic devices, such as laptops or tablet computers with touch-sensitive surfaces (e.g., touch screen displays and/or touchpads), are, optionally, used. It should also be understood that, in some embodiments, the device is not a portable communications device, but a device such as a desktop computer, a laptop computer, a tablet computer, a multimedia player device, a gaming system, or an extended reality device/system (AR/VR). In some embodiments the electronic device includes a touch-sensitive surface. In some embodiments, the electronic device does not include a touch-sensitive surface but rather a display device (e.g., a display) and one or more separate control devices display (e.g., mouse, keyboard, stylus, etc.) for interacting with the device including graphics displayed on the display device.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a gaming application, a telephone application, a video conferencing application, an e-mail application, an instant messaging application, a workout support application, a photo management application, a digital camera application, a digital video camera application, a web browsing application, a digital music player application, and/or a digital video player application. In addition to the applications recited above, the device may support other applications that include media (e.g., audio) playback functionality.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1 is a block diagram illustrating portable multifunction device 100 with touch-sensitive display surface 112 in accordance with some embodiments. Touch-sensitive surface 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display surface 112 of device 100 or touchpad (e.g., a touch sensitive surface that is separate from the display device). These components optionally communicate over one or more communication buses or signal lines 103.

It should be appreciated that device 100 is only one example of a portable multifunction device, and that device 100 optionally has more or fewer components than shown, optionally combines two or more components, or optionally has a different configuration or arrangement of the components. The various components shown in FIG. 1 are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication.

Audio circuitry 110, speaker 111, and microphone 113 provide an audio interface between a user and device 100. Speaker 111 converts the electrical signal to human-audible sound waves. Audio circuitry 110 also receives electrical signals converted by microphone 113 from sound waves.

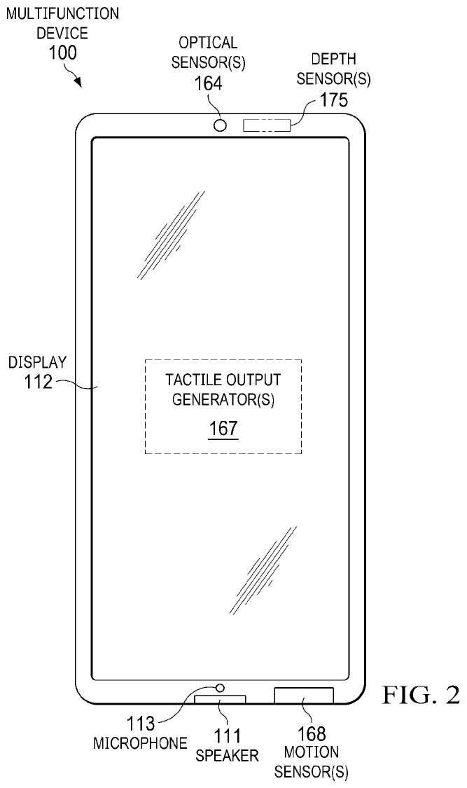

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

Touch-sensitive surface 112 provides an input interface and an output interface between the device and a user. Display controller 156 receives and/or sends electrical signals from/to touch surface 112. Touch surface 112 displays visual output to the user. The visual output optionally includes graphics, text, icons, video, and any combination thereof (collectively termed “graphics”). In some embodiments, some or all of the visual output optionally corresponds to user-interface objects.

Touch surface 112 has a touch-sensitive surface, sensor, or set of sensors that accepts input from the user based on haptic and/or tactile contact. Touch surface 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch surface 112. In an exemplary embodiment, a point of contact between touch screen 112 and the user corresponds to a finger of the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1 shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen surface 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display.

Device 100 optionally also includes one or more depth camera sensors 175. FIG. 1 shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100.

Device 100 optionally also includes one or more tactile output generators 167. FIG. 1 shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device).

Device 100 optionally also includes one or more accelerometers 168. FIG. 1 shows accelerometer 168 coupled to peripherals interface 118. Alternately, accelerometer 168 is, optionally, coupled to an input controller 160 in I/O subsystem 106. Device 100 optionally includes, in addition to accelerometer(s) 168, a magnetometer and a GPS (or GLONASS or other global navigation satellite system (GNSS)) receiver for obtaining information concerning the location and orientation (e.g., portrait or landscape) of device 100.

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136.

Operating system 126 (e.g., Android, Tizen, Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.).

Contact/motion module 130 optionally detects contact with touch surface 112 (in conjunction with display controller 156) and other touch-sensitive devices (e.g., a touchpad or physical click wheel).

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Video and music player module 152, which merges video player module and music player module;
Map module 154; and/or
Online video module 155.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch surface and/or a touchpad. By using a touch surface (e.g., a touch screen) and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 2 illustrates a portable multifunction device 100 having a touch surface 112 in accordance with some embodiments. In this example embodiment, touch surface 112 is a touch screen that optionally displays one or more graphics within a UI. In this embodiment, as well as others described below, a user is enabled to select one or more of the graphics by making a gesture on the graphics, for example, with one or more fingers (not drawn in the figure) or one or more styluses (not drawn in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that interacts with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button, optionally, used to navigate to any application 136 in a set of applications that are, optionally, executed on device 100. Alternatively, in some embodiments, the menu button is implemented as a soft key in a graphical UI (GUI) displayed on touch surface 112. In some embodiments, device 100 includes touch surface 112, menu button, back button, and an overview button.

As used here, the term “affordance” refers to a user-interactive GUI object that is, optionally, displayed on the display screen of device 100 (FIG. 1). For example, an image (e.g., icon), a button, and text (e.g., hyperlink) each optionally constitute an affordance.

Attention is now directed towards embodiments of UIs and associated processes that are implemented on an electronic device, such as portable multifunction device 100 shown in FIG. 1.

FIGS. 3A-3V illustrate exemplary user interfaces for capturing images, in accordance with some embodiments. The user interfaces shown in the figures are used to illustrate the processes described below, including the processes described in reference to FIGS. 4A and 4B.

As depicted in FIG. 3A, device 100 includes speaker 111, display 112 (e.g., a display device), microphone 113, one or more optical sensors 164 (e.g., a camera, a front facing camera), one or more output generators 167, and one or more depth sensors 175. In some embodiments, device 100 includes optical sensors 164 and no depth sensors 175. In some embodiments, device 100 is a mobile phone, such as a smartphone. In some embodiments, device 100 includes one or more features of devices 100.

As depicted in FIG. 3A, capture user interface 302 is displayed on display 112 which includes preview portion 304, including target area (304-2) visually distinguished from non-target area (304-1), and instructional prompt 306. Preview portion 304 continuously displays images (e.g., live video) as they are captured by camera 164. As depicted in FIG. 3A, preview portion 304 displays an image of device user 303 who is positioned in front of the camera 164 but off center (e.g., relative to the camera boresight and/or device centerline), such that the head of user 303 is not contained within target area 304-2.

As depicted in FIG. 3B, in response to text instruction presented on display 112 (and/or a spoken audio prompt), user 303 has repositioned their head relative to camera 164 so that their head is inside target area 304-2, as illustrated by the image of user 303 appearing more centered relative to target area 304-2 and by a change in the visual appearance of target area 304-2 (e.g., colored shading). In response to detecting this change in the head position of user 303, device 100 displays capture button 308 for initiating an image capture process on user interface 302 and ceases displaying instructional prompt 306 on user interface 302. In some embodiments, one or more other criteria is confirmed prior to displaying capture button 308 and/or ceasing display of instructional prompt 306.

FIG. 3C depicts device 100 receiving user input 310-1 (e.g., a tap) on capture button 308. In response to receiving user input 310-1, device 100 displays user interface 302 as depicted in FIG. 3D, which includes countdown animation graphic 312. After countdown animation graphic 312 completes playback, device 100 displays user interface 302 as depicted in FIG. 3E.

As depicted in FIG. 3E, device 100 has initiated capture of a series of images corresponding to the image of device user 303 displayed in preview portion 304 (e.g., real-time images capture by the camera) and displays an instructional prompt 314 to guide the user 303 to change their position relative to the camera. As depicted in FIG. 3E, instructional prompt 314 includes both textual and symbolic (e.g., a directional arrow) components. In some embodiments, device 100 outputs an audible prompt through speaker 111 corresponding to instructional prompt 314.

FIG. 3F depicts use interface 302 after user 303 has rotated their head relative to the boresight of camera 164 (or more generally, relative to device 100) past a predetermined rotation angle (e.g., x degrees yaw (e.g., x=50 degrees) in a first direction of rotation). On user interface 302, instructional prompt 314 has been replaced with instructional prompt 316 (“stop”) and image 303 is updated in preview portion 304 to reflect the change in position of the head of user 303.

FIG. 3G depicts device 100 after displaying instructional prompt 316, as user 303 has begun to rotate back towards the camera. As depicted in FIG. 3G, instructional prompt 316 has been replaced with an exemplary instructional prompt 318 (“Slowly turn back to look at your phone”).

FIG. 3H depicts use interface 302 after user 303 has rotated their head relative to the boresight of camera 164 (or more generally, relative to device 100) back to a central position (e.g., user 303 is looking at the camera). As depicted in FIG. 3H on user interface 302, instructional prompt 318 has been replaced with prompt 320 indicating to user 303 that a portion of the capture process has been successfully (“check” mark) completed.

FIG. 3I depicts device 100 after displaying instructional prompt 320, as user 303 has begun to rotate away from the camera in a different direction. As depicted in FIG. 3I, instructional prompt 320 has been replaced with an exemplary instructional prompt 322 (“Slowly turn back to look to the left”), providing further positional guidance to user 303.

FIG. 3J depicts use interface 302 after user 303 has rotated their head relative to the boresight of camera 164 (or more generally, relative to device 100) past a predetermined rotation angle (e.g., x degrees yaw (e.g., x=50 degrees yaw) in a second direction of rotation). On user interface 302, instructional prompt 322 has been replaced with instructional prompt 324 (“stop”) and image 303 is updated in preview portion 304 to reflect the change in position.

FIG. 3K depicts device 100 after displaying instructional prompt 324, as user 303 has begun to rotate back towards the camera. As depicted in FIG. 3K, instructional prompt 324 has been replaced with an exemplary instructional prompt 326 (“Slowly turn back to look at your phone”).

FIG. 3L depicts use interface 302 after user 303 has rotated their head relative to camera 164 (or more generally, relative to device 100) back to a central position (e.g., user 303 is looking at the camera). As depicted in FIG. 3L on user interface 302, instructional prompt 326 has been replaced with prompt a prompt indicating to user 303 that a portion of the capture process has been successfully completed and a continue button 328 is displayed.

FIG. 3M depicts device 100 receiving user input 310-2 (e.g., a touch input) on continue button 328. In response to receiving user input 310-2, device 100 displays demographic entry user interface 303 as depicted in FIG. 3N, which includes birth sex affordances 332-1, 332-2, and 332-3, age affordance 334, and skip affordance 336.

FIG. 3O depicts device 100 receiving user input 310-3 (e.g., a touch input) on birth sex affordance 332-1 (“Male”). In response to receiving user input 310-3, device 100 updates demographic entry user interface 303 as depicted in FIG. 3P. As depicted in FIG. 3P, birth sex affordance 332-1 is highlighted and continue button 338 is displayed.

FIG. 3Q depicts device 100 receiving user input 310-4 (e.g., a touch input) on age affordance 334. In response to receiving user input 310-4, device 100 updates the demographic entry user interface 303 as depicted in FIG. 3R which includes virtual keyboard 340 for entry of numeric data. FIG. 3S depicts device 100 receiving user input 310-5 (e.g., a tap) on done affordance 341 and now displaying user interface 330 with numeric age data displayed on age affordance 334.

FIG. 3T depicts device 100 receiving user input 310-6 (e.g., a touch input) at continue affordance 338. In response to receiving user input 310-6, device 100 displays PHRTF processing interface 342 as depicted in FIG. 3U while generating a personalize PHRTF data based the series of images captured throughout the guided image capture process and the data entered via demographic user interface 330.

FIG. 3V depicts device 100 displaying PHRTF processing interface 342 after generation of personalized PHRTF data been completed and includes done button 344.

FIGS. 4A and 4B are a flow diagram illustrating a process for capturing image data using an electronic device, in accordance with some embodiments. Process 400 is performed at an electronic device (e.g., 100) with a display (e.g., 112) and a camera (e.g. 164). In some embodiments, the electronic device also includes a set of sensors (e.g., motion sensor such as gyroscope, accelerometer, etc.). Some operations in process 400 are, optionally, combined, the orders of some operations are, optionally, changed, and some operations are, optionally, omitted.

As described below, process 400 provides an intuitive way for capturing image data, in particular image data associated with a user of the electronic device suitable for personalizing audio output from the device. The method reduces the cognitive burden on a user seeking to capture image data suitable for performing image-based device personalization, thereby creating a more efficient human-machine interface. For battery-operated computing devices, enabling a user to monitor noise exposure levels faster and more efficiently conserves power and increases the time between battery charges.

At step 402, the electronic device displays, on the display, a user interface including a preview portion displaying images (e.g., discrete images or frames of video) corresponding to image data captured by the camera.

At step 408, the electronic device performs a capture process including, at step 408-1 capturing a series of images corresponding to preview images in the preview portion using the camera and determining pose data associated with the series of images, and at step 408-2, in accordance with the pose data meeting or exceeding a first threshold causing output of a first set of instructional prompts (e.g., prompts instructing the user of the device cease rotating their head away from the device (e.g., 316) and/or to rotate their head towards the device (e.g., 318), and in accordance with the pose data meeting or exceeding a second threshold, causing output of a second set instructional prompts (e.g., prompts instructing the user of the device cease rotating their head away from the device (e.g., 324) and/or to rotate their head towards the device (e.g., 326).

In some embodiments, the series of images includes a head and/or torso of a user of the device. In some embodiments, current pose data includes an angular value (e.g., degrees or radians) associated with a user head pose represented in respective images (e.g., an estimated pitch, yaw, or roll). In some embodiments, the current pose data includes values of velocity and/or acceleration associated with the angular value.).

In some embodiments, the threshold is a fixed angular value of rotation in a first direction (e.g., x degrees (e.g., x=50 degrees, 45 degrees, etc.), counterclockwise). In some embodiments, the threshold is a fixed angular value of rotation in a first direction (e.g., x degrees (e.g., x=50 degrees, 45 degrees, etc.), clockwise). In some embodiments, the first and second threshold values have the same magnitude.

In some embodiments, the first and second threshold values have the opposite magnitudes (e.g., −50 degrees and +50 degrees).

At step 410, the electronic device ceases the capture process (e.g., causing the device to cease concurrently capturing and determining associated pose data) in response to a determination that a set of sufficiency criteria are met.

At step 412, the device generates data corresponding to a set of PHRTFs based on a subset of the series of images associated with pose data meeting or exceeding the first threshold, a subset of the series of images associated with pose data meeting or exceeding the second threshold, and a generative model (e.g., a machine learning model (e.g., a deep learning neural network) trained to output PHRTF data from input data), where the subset of the series of images is a non-overlapping subset of the series of images. In some embodiments, the input data may be derived from the subset of the series of images associated with pose data meeting or exceeding the first threshold, and the subset of the series of images associated with pose data meeting or exceeding the second threshold. In some embodiments, the input data may be derived from user input received at the electronic device (e.g., See FIGS. 3N-3T and corresponding descriptions). In some embodiments, the generative model includes a convolutional neural network.

At steps 414-418 respectively, the device receives original audio data, processes the original data based on data corresponding to a pair PHRTFs of the set of PHRTFs to the original audio to generate personalized audio data, and causes output of the personalized audio data (e.g., via a speaker of the electronic device or a speaker physically or wirelessly coupled to the electronic device).

In some embodiments, generating data corresponding to a set of PHRTFs is further based on a subset of images of the series of images (e.g., one or more) corresponding to a frontal pose (e.g., images where the user's head is facing towards the camera; images captured during a displayed countdown animation graphic 310; images captured after capturing a subset of the series of images associated with the pose data meeting or exceeding the first threshold and prior to capturing a subset of the series of images associated with the pose data meeting or exceeding the second threshold), where the subset of the series of images corresponding to a frontal pose is a non-overlapping subset of the series of images.

In some embodiments, the subset of images of the series of images corresponding to a frontal pose, the subset of the series of images associated with pose data meeting or exceeding the first threshold, or the subset of the series of images associated with pose data meeting or exceeding the second threshold are selected based on at least one of: image metadata (e.g., ISO or shutter speed) of respective images of the series of images, pose data (e.g., yaw) of respective images of the series of images, and device position data (e.g., motion data at time of capture) associated with respective images of the series of images.

In some embodiments, the device obtains a demographic data associated with a device user and generates data corresponding to a set of PHRTFs is further based the demographic data. In some embodiments, generating data corresponding to a set of PHRTFs is performed on the device. In some embodiments, generating data corresponding to a set of PHRTFs includes transmitting the series of images or subset of the series of images to a server device different than the device; and receiving the data corresponding to a set of PHRTFs from the server device, where the subset of the series of images is a non-overlapping subset of the series of images.

In some embodiments, the device displays, after ceasing the capture process, a second user interface (e.g., 330) including one or more affordances associated with at least one of, user age and user birth sex (or gender), and receives a demographic data via user input at one or more of the affordances associated with at least one of: a user age and a user birth sex (or gender). Birth sex refers to the sex (male or female) assigned to an infant, most often based on the infant's anatomical and other biological characteristics (e.g., reproductive organs and functions that derive from the chromosomal complement [generally XX for female and XY for male]). Sometimes referred to as birth sex, natal sex, biological sex or sex, sex assigned at birth, gender assigned at birth.

In some embodiments, the current pose data represents a yaw angle values and wherein the first threshold and second threshold are yaw angle values associated with a pose of user's head. In some embodiments, the pose data includes yaw velocity value and/or a yaw acceleration value.

In some embodiments, capturing a series of images using the camera is performed at a frame rate varying based on at least one of: image metadata (e.g., ISO or shutter speed) of respective images of the series of images, pose data (e.g., yaw) of respective images of the series of images, and device position data (e.g., motion data at time of capture) associated with respective images of the series of images.

In some embodiments, the device causes output of one or more prompts (e.g., an audible and/or visual instruction for the user to slow rotation of their head) in response to a determination that pose data associated with an angular velocity and/or acceleration is above a threshold value.

In some embodiments, the device, in accordance with a determination that current pose data is unavailable (e.g., the device cannot determine pose for one or more images/frames), causes output of the first or second set of instructional prompts after a period of time.

In some embodiments, the period of time is calculated based feature landmarks determined in respective images in the series of images and at least one of: pose velocity data or pose acceleration data associated with the respective images. In some embodiments, causing output of a first set of instructional prompts, is performed in accordance with a determination that one or more velocity and/or acceleration values are below a respective velocity and/or acceleration threshold. In some embodiments, causing output of a second set of instructional prompts, is performed in accordance with a determination that one or more velocity and/or acceleration values are below a respective velocity and/or acceleration threshold.

In some embodiments, after meeting or exceeding the first or second threshold, and in accordance with the current pose data meeting or exceeding a third threshold between the first and second thresholds (e.g., a reference pose angle corresponding to a pose facing camera; see, for example, 303 at FIG. 3L), displaying a third affordance (e.g., confirmation graphic, check mark, or continue graphic; 328).

In some embodiments, the device, in accordance with a determination of a failure to meet or exceed the first or second threshold, repeating the capture process.

In some embodiments, after meeting or exceeding the first and second threshold, and in accordance with the determination that the series of images includes a quantity of images depicting a left ear, a right ear, and a center view of the user above a pre-determined threshold, displaying a third affordance (e.g., check mark or continue graphic, 328).

In some embodiments, meeting the sufficiency criteria includes determining that the series of images includes: a set of one or more images associated with pose data meeting or exceeding the first threshold and a set of one or more images associated with pose data meeting or exceeding the second threshold. In some embodiments, meeting the set sufficiency criteria includes determining that current pose data at least met or exceeded the first threshold and/or the second threshold during the capture process.

In some embodiments, the device, while displaying the first preview portion displaying images captured by the camera device and without displaying the first affordance (e.g., 308), calculates first data associated with a first set capture criteria and in accordance with a determination based on the first data, that the first set of capture criteria are met, displays the first affordance on the first user interface, and causes output of a third set of instructional prompts, and prior to performing the capture process, determines a reference pose data associated with an image captured by the camera at a first time (e.g., reference pose).

In some embodiments, the device, in accordance with a determination based on the first data, that the first set of capture criteria are not met, refrains from displaying the first affordance and causes display of visual (e.g., 306) or auditory feedback associated with the at least one criterion the first set of capture criterion.

In some embodiments, the first set of capture criteria include a device position or a device orientation. In some embodiments, the device position or the device orientation are associated with the device being positioned vertically (e.g., the camera is pointed in a direction approximately normal to the force of gravity), the device being within a specified distance from a user's face (e.g., within a range such as between 15 cm and 60 cm as estimated based on image data from the camera or depth sensor (e.g., Lidar) on the device), or the device camera being positioned such that captures a user's face in the center of images (e.g., the user's face is centered relative to the camera position).

In some embodiments, the first set of capture criteria; include at least one of: face detected (e.g., device detects a face in image data captured by the camera), adequate lighting detected (e.g., image meta data indicates ISO is below an iso threshold value), and obstruction of ear and/or eye not detected (e.g., device fails detects eyewear or hair covering ears in image data captured by the camera).

In some embodiments, an augmented reality framework on the electronic device is used for head pose estimation and camera pose estimation, and a subset of image frames provided by the framework are selected to ensure a minimum angular distance between frames for each side of the user's head (e.g., 0.6 degrees).

In some embodiments, for each side of the user's head image frames are selected within a specified range of angular distances (e.g., 20 to 55 degrees in yaw). The selected images are input into a machine learning model (e.g., a deep learning neural network) to detect the user's ears. In some embodiments, the network (e.g., a convolutional neural network) is trained to detect human ears using, for example, images of ears under different conditions (e.g., different angles, lighting conditions, etc.). In some embodiments, synthesized or augmented images of ears are included in the training data. An ear-landmark detection is then performed on the frames where ears have been detected by the machine learning model.

In some embodiments, a subset of the captured images (e.g., a subset of the series of images associated with the pose data meeting or exceeding the first threshold, a subset of the series of images associated with the pose data meeting or exceeding the second threshold) is selected to ensure a minimum angular distance of head rotation between image frames (e.g., 0.6 degrees). Constraining the angular distance between images has several technical effects, including ensuring that the image capture process is efficient by limiting capture only to data useful for image-based PHRTF generation. For example, image-based PHRTF generation techniques utilizing multi-angulation techniques (e.g., for projecting 2D data into 3D coordinates) are less accurate when there is insufficient angular distance between the pose angles of the 2D input image data.

In some embodiments, a subset of the captured images (e.g., a subset of the series of images associated with the pose data meeting or exceeding the first threshold, a subset of the series of images associated with the pose data meeting or exceeding the second threshold) is selected to constrain the images by an overall angular distance range (e.g., a yaw angle range). Constraining the angular distance range has several technical effects, including ensuring that the image capture process is efficient by limiting capture to only reliable data. For example, pose angles provided by face recognition algorithms may become unreliable past a certain maximum angle of head rotation.

In some embodiments, image data from one ear (e.g., a left ear) is used to derive image data for use in place of data from the other ear (e.g., the right ear) under the assumption that the ears are symmetrical.

In some embodiments, if an insufficient number of qualified images cannot be captured, demographic based head information (e.g., average head diameter/radius for males or females) can be used to compute a default PHRTF.

FIGS. 5A-5K are screen shots of alternative user interfaces for capturing image data using an electronic device, in accordance with some embodiments.

As depicted in FIG. 5A, capture user interface 502 includes preview portion 504, including target area (504-2) visually distinguished from non-target area (504-1), and instructional prompt 506. In the example shown, instructional prompt 506 states, “Center your head in the frame.” Preview portion 504 displays images as they are captured by camera 164. As depicted in FIG. 5A, preview portion 504 displays an image of user 503 who is positioned in front of optical and depth sensors 164, 175, such that the head of user 503 is centered within target area 504-2 in compliance with instructional prompt 506.

As depicted in FIG. 5B, in response to determining that the user's head is centered in the target area 504-2, instructional prompt 506 is replaced with an exemplary feedback prompt 507, which in this example is, “Great!” This example feedback prompt 507 informs the user that their head is centered in the frame. Also shown in FIG. 5B are direction indicators 508-1 to 508-4 located at the top, bottom and sides of target portion 504-2. Direction indictors 508-1 and 508-2 indicate head pitch direction (pitch head up or down) and direction indicators 508-3 and 508-4 indicate head yaw direction (turn head right or left). In the example shown, the direction indicators are arrows. In other embodiments, the direction indicators can be any other suitable graphic that can indicate left and right (e.g., yaw angle directions).

As depicted in FIG. 5C, instructional prompt 506 now includes the example text, “Tilt your head as indicated.” Also, direction indicator 508-3 (e.g., an arrow) changes to a different color than direction indicators 508-1, 508-2 and 508-4 (also arrows in this example) to indicate to user 503 the requested direction of tilt. For example, direction indicator 508-3 can change from green to red while direction indicators 508-1, 508-2 and 508-3 remain green. In some embodiments, other colors or graphic can be used and/or other direction indicator styles (e.g., flashing arrows) for direction indicators, which can be static, animated or both.

As depicted in FIG. 5D, user 503 complies with instructional prompt 506 resulting in another instructional prompt 506 being displayed which includes the example instruction, “Hold still please.” An image of the head of user 503 is captured by optical and depth sensors 164, 175. In some embodiments, countdown animation graphic 310 is displayed to indicate that images are being captured. After countdown animation graphic 310 completes playback, device 100 displays user interface 502 as depicted in FIG. 5E.

In FIG. 5E, instructional prompt 506 now displays the example instruction, “Slowly turn your head to look over your right shoulder.” There is also displayed direction arrow 509, indicating to user 503 the direction to turn their head. Also, in some embodiments the right boundary of target portion 504-2 (right half) is highlighted (as shown) or otherwise augmented to indicate the direction user 503 is to turn their head.

As depicted in FIG. 5F, user 503 has complied with the prompt and an image of the right ear of user 503 is captured by optical and depth sensors 164, 175. In some embodiments, countdown animation graphic 310 is displayed to indicate that images are being captured. After image capture, instructional prompt 506 includes the example text, “Turn back to look at your phone.”

As depicted in FIG. 5G, user 503 complied with the prompt and example feedback prompt 507 is displayed, stating “Great!” Also, direction indicators 508-1 to 508-4 are displayed again. As depicted in FIG. 5H, a second instructional prompt 506 includes the example text: “Hold still please.”

FIGS. 5I and 5J and are similar to FIGS. 5E and 5F but are a mirror image and directed to the capture of images of the left ear of user 503. As depicted in FIG. 5K, feedback prompt 507 includes the example text, “Capture complete!”, which indicates to the user that the image capture process has been completed.

In some embodiments, instructional prompt 506 and feedback prompt 507 are accompanied and/or replaced by spoken audio of instructional prompt 506, haptic/tactile feedback or feedback prompt 507.

FIGS. 6A-6E are screen shots of another alternative user interface 600 for creating a PHRTF without capturing images, in accordance with some embodiments. The screen shots shown in user interface 600 illustrate user input of head size data using slider affordance and can be used in place of the process described in reference to FIGS. 3A-3L.

Referring to FIG. 6A, slider affordance 601-1 updates silhouette 602-1 (e.g., increases silhouette size) and textual descriptions 603-1 (e.g., “Extra small” “About 6¾ (XS) hat size”) when slider affordance 601-1 is repositioned by the user.

In addition to the user selected head size data, the user inputs their demographic information (e.g., selecting an affordance corresponding to the user's birth sex or gender), which is used with the head size data to generate the PHRTF data without using captured image data. Affordance 604-1 (e.g., a virtual button with the exemplary label Create My Profile) is selected by the user to start the creation of the PHRTF based on the head size data and demographic data. FIGS. 6B-6E illustrate the same process described in reference to FIG. 6A for small, medium, large and extra-large head sizes, respectively.

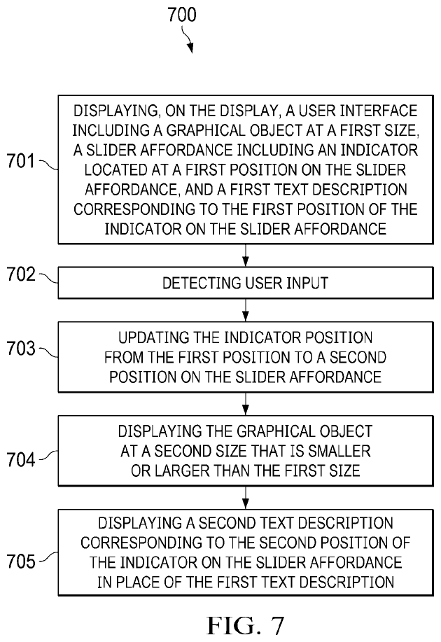

FIG. 7 is a flow diagram illustrating a process for generating PHRTFs, in accordance with some embodiments. Process 700 is performed at an electronic device (e.g., 100) with a display (e.g., 112). In some embodiments, the electronic device also includes a set of sensors (e.g., motion sensor such as gyroscope, accelerometer, etc.). Some operations in process 700 are, optionally, combined, the orders of some operations are, optionally, changed, and some operations are, optionally, omitted.

As described below, process 700 provides an intuitive way for generating PHRTFs without capturing images. The process reduces the cognitive burden on a user seeking to capture image data suitable for performing image-based device personalization, thereby creating a more efficient human-machine interface. For battery-operated computing devices, enabling a user to capture image data for personalizing audio output from the device faster and more efficiently conserves power and increases the time between battery charges.

The process 700 can be performed on an at electronic device with a display. The process 700 includes: displaying, on the display, a user interface including a graphical object at a first size, a slider affordance including an indicator located at a first position on the slider affordance, and a first text description corresponding to the first position of the indicator on the slider affordance (701). While displaying the graphical object, process 700 continues by detecting user input (702), and responsive to detecting the user input: updating the indicator position from the first position to a second position on the slider affordance (703); displaying the graphical object at a second size that is smaller or larger than the first size (704); and displaying a second text description corresponding to the second position of the indicator on the slider affordance in place of the first text description (705).

In some embodiments, the process further includes generating personalized head related transfer function (PHRTF) data corresponding to a set of PHRTF related transfer functions based on data corresponding to the displayed size of the graphical object and the first or second text description and a generative model.

In some embodiments, generating PHRTF data corresponding to a set of PHRTF related functions is performed in response to detecting user input at a create profile affordance (e.g. 604) presented on the touch sensitive display.

In some embodiments, generating PHRTF data includes applying demographic data associated with the user (e.g., user age and user birth sex; See 3N-3T) to the generative model.

In some embodiments, generating PHRTF data excludes using image data corresponding to the user.

In some embodiments, the first size (e.g., See 602-1) of the graphical object is smaller than the second size (e.g., See 602-2, 602-3, 602-4, etc.) of the graphical object.

In some embodiments, the first size of the graphical object is larger than the second size of the graphical object.

In some embodiments, detecting user input includes but is not limited to, detecting a slide and/or drag input (e.g., which includes detecting initiation of an input at the first position and ceasing of input at the second position). For example, finger down, stylus down, mouse click hold at a position corresponding to the indicator at the first position followed by finger up, stylus up, mouse click release at a position corresponding to the second position.

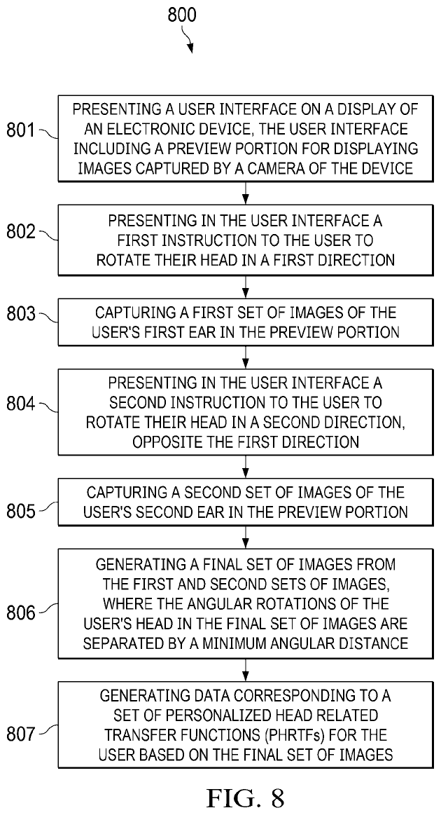

FIG. 8 is a flow diagram illustrating another process 800 for capturing image data using an electronic device, in accordance with some embodiments. Process 800 can be implemented by the portable multifunction device 100, a described in reference to FIG. 1.

As described below, process 800 provides an intuitive way for capturing image data, in particular image data associated with a user of the electronic device suitable for personalizing audio output from the device. The process reduces the cognitive burden on a user seeking to capture image data for performing image-based device personalization, thereby creating a more efficient human-machine interface. For battery-operated computing devices, enabling a user to capture image data for personalizing audio output from the device faster and more efficiently conserves power and increases the time between battery charges. The process also provides for computationally efficient selection of a subset captured image data that is suitable for downstream processes for device personalization (e.g., generating PHRTFs).

Process 800 includes: presenting a user interface on a display of an electronic device (801). The user interface includes a preview portion having a target area for displaying images captured by a camera of the device. Process 800 continues by presenting in the user interface a first instruction to the user to rotate their head in a first direction (802) and capturing a first set of images of the user's first ear in the target area (803). Process 800 continues by presenting in the user interface a second instruction to the user to a rotate their head in a second direction, opposite the first direction (804) and capturing a second set of images of the user's second ear in the target area (805). Process 800 continues by generating a final set of images from the first and second sets of images (806). A subset of the final set of images is selected to ensure a minimum angular distance of head rotation between image frames, and to constrain the images by an overall angular distance range (e.g., a maximum yaw angle range less than 110 degrees). Process 800 continues by generating data corresponding to a set of PHRTFs for the user based on the final set of images (807).

In some embodiments, capturing the first set of images of the user's first ear in the target area and capturing the second set of images of the user's second ear in the target area includes determining respective angular head rotation data for each image. In some embodiments, the final set of images are selected to have an overall maximum angular distance of head rotation between a first image in the final set of images and a last image in the final set of images of the user that is less than 110 degrees (e.g., 90 degrees). That is, selecting the final set of images includes a process based on the determined respective angular head rotation data.

In some embodiments, the device scales at least a portion of the first and second sets of images based on one or more frontal view images of the user prior to generating data corresponding to a set of PHRTFs for the user based on the final set of images (807). The term “scale” refers to a ratio-based adjustment (e.g., resizing)of pose coordinates or reference coordinates (e.g., 3D world coordinates, anatomical coordinates, photogrammetric, coordinates, landmark coordinates) corresponding to the image data. In some embodiments, the device captures the frontal view images of the user prior to capturing the first set of images of the users first ear. In some embodiments, the device captures frontal view images after determining alignment of the user relative to the camera and during a displayed countdown animation (e.g., during one or more of steps illustrated in FIGS. 3D, 5D, 5H, etc.). In some embodiments, the device captures the frontal view images of the user after capturing the first set of images of the users first ear. In some embodiments, the device may capture frontal view images during a transitional phase between capturing the first set of images of the users first ear and capturing the second set of images of the users second ear (e.g., during one or more of steps illustrated in FIGS. 3H, 5G, 5H, etc.). In some embodiments, the device captures the frontal view images of the user after capturing the first set of images of the users first ear and after capturing the second set of images of the users second ear (e.g., during one or more of steps illustrated in FIGS., 3L, 5K, etc.).

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

1. A method comprising:
at an electronic device with a display and a camera:
displaying, on the display, a user interface including a preview portion displaying images corresponding to image data captured by the camera; and
while displaying the images in the preview portion, performing a capture process including:
capturing a series of images corresponding to preview images in the preview portion using the camera;
determining pose data associated with the series of images;
in accordance with the pose data meeting or exceeding a first threshold, causing output of a first set of instructional prompts; and
in accordance with the pose data meeting or exceeding a second threshold, causing output of a second set of instructional prompts; and
ceasing the capture process in response to a determination that a set of sufficiency criteria are met.

2. The method according to claim 1, further comprising: generating data corresponding to a set of personalized head related transfer functions (PHRTFs) based on: a subset of the series of images associated with the pose data meeting or exceeding the first threshold; and a subset of the series of images associated with the pose data meeting or exceeding the second threshold; and a generative model.

3. The method according to claim 2, further comprising:
receiving original audio data;
processing the original data based on data corresponding to a pair of PHRTFs of the set of PHRTFs to the original audio to generate personalized audio data; and
causing output of the personalized audio data.

4. (canceled)

5. The method according to claim 4, wherein the subset of images of the series of images corresponding to the frontal pose, the subset of the series of images associated with the pose data meeting or exceeding the first threshold, or the subset of the series of images associated with the pose data meeting or exceeding the second threshold are based on at least one of:
image metadata of respective images of the series of images;
pose data of respective images of the series of images; and
device position data associated with respective images of the series of images.

6. The method according to claim 2, further comprising:
obtaining a demographic data associated with the user; and
wherein generating data corresponding to a set of PHRTFs is further based the demographic data.

7. (canceled)

8. (canceled)

9. The method according to claim 1, further comprising:
displaying, after ceasing the capture process, a second user interface including one or more affordances associated with at least one of user age or user birth sex; and
receiving demographic data via user input at one or more of the affordances associated with at least one of a user age or a user birth sex.

10. The method according to claim 1, wherein the pose data represents yaw angle values; and wherein the first threshold and second threshold are yaw angle values associated with a pose of the user's head.

11. (canceled)

12. (canceled)

13. The method according to claim 4, wherein the pose data includes at least one of a yaw velocity value or a yaw acceleration value; and further comprising: causing output of one or more prompts in response to a determination that the at least one of yaw velocity value or yaw acceleration value is above the first or second threshold value.

14. (canceled)

15. (canceled)

16. The method according to claim 1, wherein the pose data includes at least one of a yaw velocity value or a yaw acceleration value; and wherein causing output the first set of instructional prompts, is performed in accordance with a determination that one or more velocity or acceleration values of the at least one of a yaw velocity value or a yaw acceleration values are below a respective velocity or acceleration threshold.

17. The method according to claim 1, causing output of a second set of instructional prompts, is performed in accordance with a determination that one or more velocity or acceleration values are below a respective velocity or acceleration threshold.

18. The method according to claim 1, wherein after meeting or exceeding the first or second threshold, and in accordance with the pose data meeting or exceeding a third threshold between the first and second thresholds, displaying a third affordance.

19. (canceled)

20. The method according to claim 18, wherein after meeting or exceeding the first and second threshold, and in accordance with the determination that the series of images includes a respective quantity of images depicting a left ear, a right ear, and a frontal view of the user above respective pre-determined thresholds, displaying a third affordance.

21. The method according to claim 1, wherein meeting the sufficiency criteria includes:
determining that the series of images includes:
a set of one or more images associated with the pose data meeting or exceeding the first threshold; and
a set of one or more images associated with the pose data meeting or exceeding the second threshold.

22. The method according to claim 1, wherein meeting the set sufficiency criteria includes determining that the pose data at least met or exceeded the first threshold or the second threshold during the capture process.

23. The method according to claim 1, further comprising:
while displaying the preview portion displaying images captured by the camera device and without displaying the first affordance:
calculating first data associated with a first set capture criterion; and
in accordance with a determination based on the first data, that the first set of capture criterion are met:
displaying the first affordance on the user interface; and
causing output of a third set of instructional prompts; and
prior to performing the capture process, determining reference pose data associated with an image captured by the camera at a first time.

24. The method according to claim 23, further comprising:
in accordance with a determination based on the first data, that the first set of capture criteria are not met:
refraining from displaying the first affordance; and
causing display of visual or auditory feedback associated with the at least one criterion of the first set of capture criterion.

25. (canceled)

26. (canceled)

27. (canceled)

28. The method according to claim 1, further comprising:
determining if a specified number of images in the series of images meet the sufficiency criterion; and
in accordance with a specified number of images in the series of images not meeting the sufficiency criterion, using demographic based head information for the user to compute a default PHRTF for the user.

29. The method according to claim 1, wherein a subset of the series of images is selected to ensure a minimum angular distance of head rotation between image frames.

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. A non-transitory computer-readable storage medium storing instructions which, when executed by a computing apparatus, cause the computing apparatus to perform the method of any of claims 1-3, 5, 6, 9, 10, 13, 16-18, 20-24, 28, and 29.

44. A computing apparatus, comprising:
a display;
at least one processor; and
memory storing instructions, which when executed by the at least one processor, cause the computing apparatus to perform the method of any of claims 1-3, 5, 6, 9, 10, 13, 16-18, 20-24, 28, and 29.
